(19) United States
(12) Patent Application Publication
(10) Pub. No.: US 2012/0185263 A1
(43) Pub. Date: Jul. 19, 2012

(54) METHODS AND SYSTEMS FOR MANAGING PRESCRIPTION DRUG BENEFIT PLANS

(76) Inventor: Timothy M. Emert, St. Louis, MO (US)

(21) Appl. No.: 13/006,071

(22) Filed: Jan. 13, 2011

(51) Int. Cl. G06Q 50/00; G06Q 10/00

(52) U.S. Cl. 705/2

(57) ABSTRACT

A method for managing payments between a prescription drug benefits manager (PBM), a pharmacy, and a client of the PBM is described. The payments are made in accordance with a prescription drug benefits plan offered by the client to an individual and managed by the PBM. The method includes receiving transaction data associated with a first prescription drug transaction from the pharmacy, the transaction data including data identifying the prescription drug benefits plan and data identifying a first medication and a dosage of the first medication. The method also includes determining at least one of a pharmacy discount goal and a client discount goal. The method also includes determining at least one of an actual pharmacy discount provided by the PBM to the pharmacy over a predefined period of time, and an actual client discount provided by the PBM to the client over the predefined period of time.

### BACKGROUND

The field of the disclosure relates generally to managing prescription drug benefit plans, and more specifically, to managing prescription drug transactions using real-time calculations.

The administration of prescription drug benefit plans offered by an employer (i.e., the payer) to an employee (i.e., the consumer) is typically managed by a prescription benefit manager (PBM). The PBM has a relationship with the employer or with a health maintenance organization (HMO), employer group, or government entity in which the employer is a member. These entities are typically referred to as clients of the PBM. The PBM also has a relationship with pharmacies that may be utilized by the consumer to obtain a prescription medication.

For example, when a consumer receives a prescription from their physician for a medication, they submit the prescription to a pharmacy to be filled. If applicable, the consumer also provides the pharmacy with information identifying the prescription benefit plan in which they are enrolled and the PBM who manages the plan. The pharmacy has an inventory of medications that were previously purchased from a drug wholesaler. The pharmacy submits the transaction to the PBM and requests payment for the prescription medication and a dispensing fee. Typically, the consumer pays the pharmacy a co-pay amount. Unlike many other purchases, the pharmacy does not transmit an amount they expect to be paid to the PBM. Rather, the PBM determines the amount they will pay the pharmacy for this transaction. The amount of payment is determined based on a contract between the pharmacy, or chain in which the pharmacy is affiliated, and the PBM. The PBM invoices the payer to reimburse the PBM for the money paid to the pharmacy to cover the consumer's transaction and for costs associated with managing the prescription drug benefit plan. The amount invoiced to the payer is determined by a contract between the PBM and the payer.

Brand name medications and generic medications are typically priced differently. Brand name medications are usually priced by discounting an average wholesale price (AWP). The AWP is a nationally published price and the discount is determined based on contracts between the PBM and the pharmacy. Generic medications are typically priced at the lesser of an amount determined by adjusting the AWP by the discount and an amount determined using a maximum allowable cost (MAC) pricing technique. MAC pricing allows the PBM to set a price for a medication on a per unit basis that is not necessarily dependent upon the manufacturer. More specifically, since multiple manufacturers may produce the same generic drug and dosage, the MAC price is applied regardless of the manufacturer or that particular manufacturer's AWP. The PBM generates MAC pricing lists that contain the amounts the PBM will pay the pharmacy for each generic drug and dosage. Typically, the pharmacy agrees that the PBM will set the MAC prices. In return for allowing the PBM to set the MAC prices, the PBM sometimes guarantees that at the end of a set period of time (e.g., three months) the PBM will have paid the pharmacy at least AWP (i.e., a total of the AWP for all generic drugs purchased by members of the prescription drug benefit plan during the set period of time) minus a contractually agreed upon discount plus a dispensing fee.

In order to fulfill this guarantee, while also achieving financial goals internal to the PBM, the PBM adjusts the MAC pricing lists throughout the set period of time, for example, monthly. Furthermore, since the guarantee is based upon the relationship between the MAC and that particular pharmacy or chain of pharmacies, the PBM may generate MAC lists specific to each PBM/pharmacy relationship. As such, in order to meet both pharmacy goals and internal PBM goals, many MAC lists are prepared and recalculated throughout the set period of time, consuming large amounts of time as well as associated costs. Furthermore, the PBM may be diverging from the goals during the time periods between updated MAC lists. Moreover, the figures used to determine MAC pricing lists are up-to-date when the calculations are being made. However, those figures may have changed by the time an individual prescription drug transaction is processed and the MAC price is used.

### BRIEF DESCRIPTION

In one aspect, a method for managing payments between a prescription drug benefits manager (PBM), a pharmacy, and a client of the PBM is provided. The payments are made in accordance with a prescription drug benefits plan offered by the client to an individual and managed by the PBM. The method includes receiving transaction data associated with a first prescription drug transaction from the pharmacy, the transaction data including data identifying the prescription drug benefits plan and data identifying a first medication and a dosage of the first medication. The method also includes determining at least one of a pharmacy discount goal and a client discount goal. The method also includes determining at least one of an actual pharmacy discount provided by the PBM to the pharmacy over a predefined period of time, and an actual client discount provided by the PBM to the client over the predefined period of time.

In another aspect, a system for managing payments between a prescription drug benefits manager (PBM), a pharmacy, and a client of the PBM is provided. The payments are made in accordance with a prescription drug benefits plan offered by the client to an individual and managed by the PBM. The system includes at least one input device associated with the pharmacy and a server system configured to be coupled to the at least one input device. The server system is configured to receive transaction data associated with a first prescription drug transaction from the pharmacy. The transaction data includes data identifying the prescription drug benefits plan and data identifying a first medication and a dosage of the first medication. The server system is also configured to determine at least one of a pharmacy discount goal and a client discount goal. The server system is also configured to determine at least one of an actual pharmacy discount provided by the PBM to the pharmacy over a predefined period of time prior to receipt of the transaction data associated with the first prescription drug transaction, and an actual client discount provided by the PBM to the client over the predefined period of time.

In yet another aspect, a computer program embodied on a computer readable medium for managing payments between a prescription drug benefits manager (PBM), a pharmacy, and a client of the PBM is provided. The payments are made in accordance with a prescription drug benefits plan offered by the client to an individual and managed by the PBM. The program includes at least one code segment that instructs a server system to receive transaction data associated with a first prescription drug transaction from the pharmacy. The transaction data includes data identifying the prescription drug benefits plan and data identifying a first medication and a dosage of the first medication. The program also includes at least one code segment that instructs a server system to determine at least one of a pharmacy discount goal and a client discount goal, and to determine at least one of an actual pharmacy discount provided by the PBM to the pharmacy over a predefined period of time, and an actual client discount provided by the PBM to the client over the predefined period of time. The program also includes at least one code segment that instructs a server system to determine at least one of a pharmacy paid ingredient cost for the first prescription drug transaction and a client billed ingredient cost for the first prescription drug transaction. The pharmacy paid ingredient cost is an amount paid by the PBM for reimbursing the pharmacy for performing the first prescription drug transaction and is based at least partially on the pharmacy discount goal and the actual pharmacy discount. Furthermore, the client billed ingredient cost is an amount billed by the PBM to reimburse the PBM for performing the first prescription drug transaction and is based at least partially on the client discount goal and the actual client discount.

### BRIEF DESCRIPTION OF THE DRAWINGS

FIG. 1 is a block diagram illustrating the relationships between a prescription benefit manager, a pharmacy, and a client.

FIG. 2 is a simplified block diagram of an exemplary computer system.

FIG. 3 is an expanded block diagram of an exemplary embodiment of a server architecture of the system shown in FIG. 2.

FIG. 4 illustrates an exemplary configuration of a client system shown in FIGS. 2 and 3.

FIG. 5 illustrates an exemplary configuration of a server system shown in FIGS. 2 and 3.

FIG. 6 is a block diagram of an exemplary method for determining an amount to pay a pharmacy for the transaction shown in FIG. 1.

FIG. 7 is a block diagram of an exemplary method for determining an amount the prescription benefit manager will bill the client for the transaction shown in FIG. 1.

FIG. 8 is a block diagram of an exemplary method for determining a maximum amount the prescription benefit manager will bill the client for the transaction shown in FIG. 1.

FIG. 9 is a block diagram of an exemplary method for determining a maximum amount the prescription benefit manager will pay the pharmacy for the transaction shown in FIG. 1.

FIG. 10 is a block diagram of an exemplary method for determining a minimum amount the prescription benefit manager will pay the pharmacy for the transaction shown in FIG. 1.

FIG. 11 is a block diagram of an exemplary method for determining the pharmacy discount goal applied to the method shown in FIG. 6 and the client discount goal applied to the method shown in FIG. 7.

### DETAILED DESCRIPTION

The methods, systems, and computer readable media described herein facilitate managing prescription drug benefits, including determining an amount to pay a pharmacy and an amount to bill a client on a per transaction basis. Determining these amounts on a per transaction basis facilitates maintaining a close proximity to preset goals by using current values to determine the amounts. The methods, systems, and computer readable media described herein ensure that discounts contractually agreed to by a pharmacy benefit manager (PBM), a client, and a pharmacy are met. Furthermore, the methods, systems, and computer readable media ensure that internal PBM financial goals are also achieved.

Technical effects of the methods, systems, and computer-readable media described herein include at least one of: (a) determining a pharmacy discount goal and an actual pharmacy discount; and (b) determining a price to pay a pharmacy for a transaction based at least partially on the pharmacy discount goal and the actual pharmacy discount.

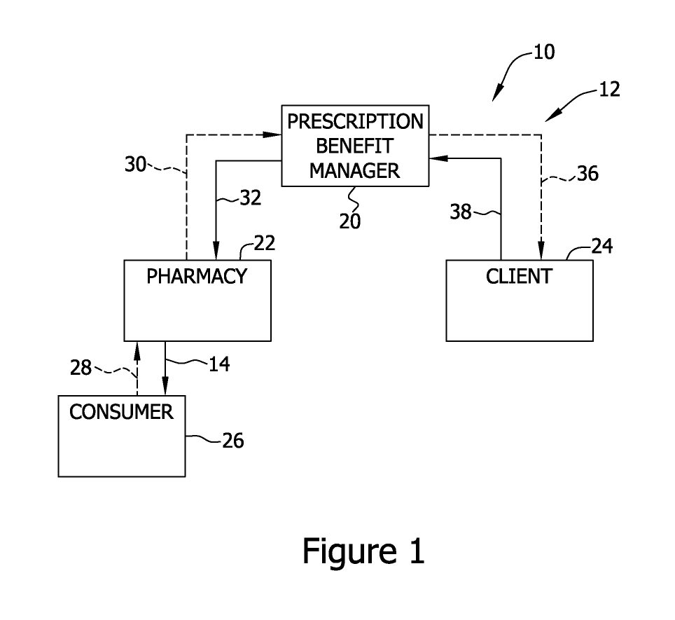

FIG. 1 is a block diagram 10 illustrating the relationships between a prescription benefit manager (PBM) 20, a pharmacy 22, a client 24, and a consumer 26. An exemplary prescription drug transaction 12 is identified by solid and dashed lines connecting PBM 20, pharmacy 22, client 24, and consumer 26. Transaction 12 occurs when consumer 26 requests that pharmacy 22 fill a prescription for a medication 14. Typically, client 24 is an employer who enters into a contract with PBM 20 to manage a prescription drug plan for employees of client 24. Consumer 26 has a relationship with client 24, for example, consumer 26 may be an employee of client 24. As a benefit to consumer 26, client 24 may offer health insurance to consumer 26. The health insurance may include a prescription drug benefit plan managed by PBM 20. Typically, PBM 20 is a company who maintains relationships with various pharmacies, and by pooling a number of clients 24, is able to negotiate terms with those pharmacies that an individual would be unable to obtain. Pharmacy 22 also benefits from a relationship with PBM 20 because by agreeing to terms with PBM 20, consumers who are members of prescription drug benefit plans managed by PBM 20 are able to patronize pharmacy 22 to take advantage of the prescription drug benefit plans.

In exemplary transaction 12, consumer 26 receives a prescription for medication 14 from a health care provider (not shown in FIG. 1). The prescription identifies medication 14, including a medication name, a number of pills or volume of liquid, and a dosage that the health care provider has prescribed to consumer 26. As referred to herein, medication 14 is a number of pills or volume of liquid and a dosage of the medication, set forth in the prescription. Consumer 26 submits consumer transaction data 28 to pharmacy 22. Consumer transaction data 28 includes the prescription and information as to the prescription drug benefit plan in which consumer 26 is enrolled. Pharmacy 22 submits pharmacy transaction data 30 to PBM 20 for approval. Pharmacy transaction data 30 includes consumer transaction data 28 as well as information identifying pharmacy 22. If PBM 20 approves, PBM 20 agrees to pay pharmacy 22 a first amount of money 32 as payment for medication 14, which pharmacy 22 will provide to consumer 26, and pharmacy 22 provides medication 14 to consumer 26. PBM 20 transmits an invoice 36 to client 24, that includes a second amount 38, to reimburse PBM 20 for the money PBM 20 paid to pharmacy 22 and for additional costs that arise for providing plan management services. Transaction 12 concludes with client 24 paying PBM 20 second amount 38, which is partially determined by the contract between PBM 20 and client 24.

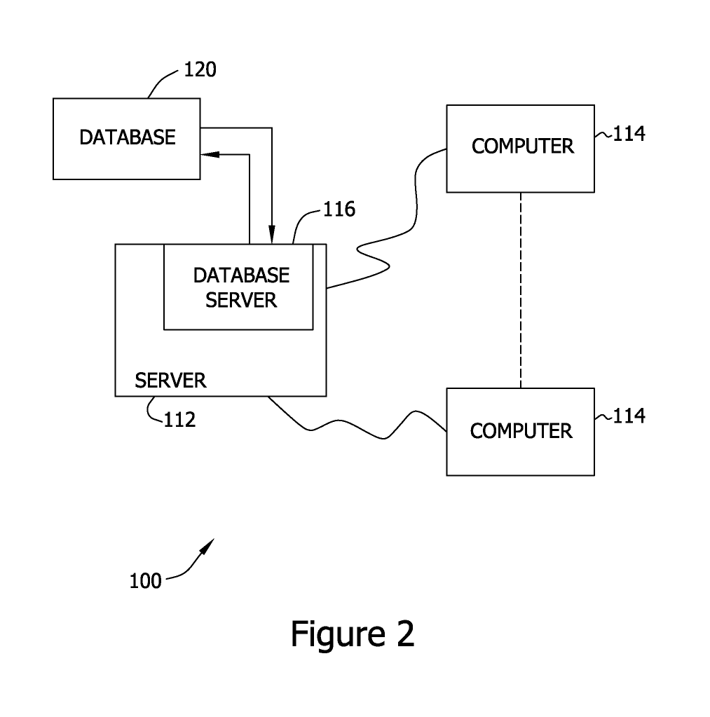

FIG. 2 is a simplified block diagram of an exemplary computer system 100. System 100 is a prescription drug benefit management system, which can be utilized by a PBM, for example, PBM 20 (shown in FIG. 1) to manage, for example, exemplary transaction 12 (shown in FIG. 1). More specifically, system 100 is utilized by PBM 20 to manage a first transaction between PBM 20 and pharmacy 22 (shown in FIG. 1), and a second transaction between PBM 20 and client 24 (shown in FIG. 1). Furthermore, system 100 can be utilized by pharmacy 22 as part of a process of initiating a prescription payment request as described below.

In the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through an interface, including but not limited to, a network, such as a local area network (LAN) or a wide area network (WAN), dial-in-connections, cable modems, and special high-speed ISDN lines. Client systems 114 could be any device capable of interconnecting to the Internet including a web-based phone, personal digital assistant (PDA), or other web-based connectable equipment. Client systems 114 further include an input device (not shown in FIG. 2) capable of reading information from a consumer's prescription drug benefit plan card and/or receiving manually entered prescription drug benefit plan information.

A database server 116 is connected to database 120, which contains information on a variety of matters, as described below in greater detail. Database 120 is also referred to herein as a data warehouse. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized. Database 120 may store prescription drug benefit plan data including, but not limited to, information identifying plan members, information identifying affiliated pharmacies, and information related to plan benefits. More specifically, database 120 may store preliminary goals and assumptions, predefined by PBM 20, including, but not limited to, financial targets internal to PBM 20, expected client mix information, expected pharmacy mix information, an expected generic fill rate, an expected cost per generic drug, a expected brand fill rate, and an expected cost per brand. As referred to herein, generic fill rate is a percentage of all drugs sold that are classified as generic drugs and brand fill rate is a percentage of all drugs sold that are not classified as generic, but rather, are branded drugs.

In the example embodiment, one of client systems 114 may be associated with a first pharmacy, for example, pharmacy 22, while another one of client systems 114 may be associated with a second pharmacy (not shown in FIG. 1). Furthermore, server system 112 may be associated with PBM 20.

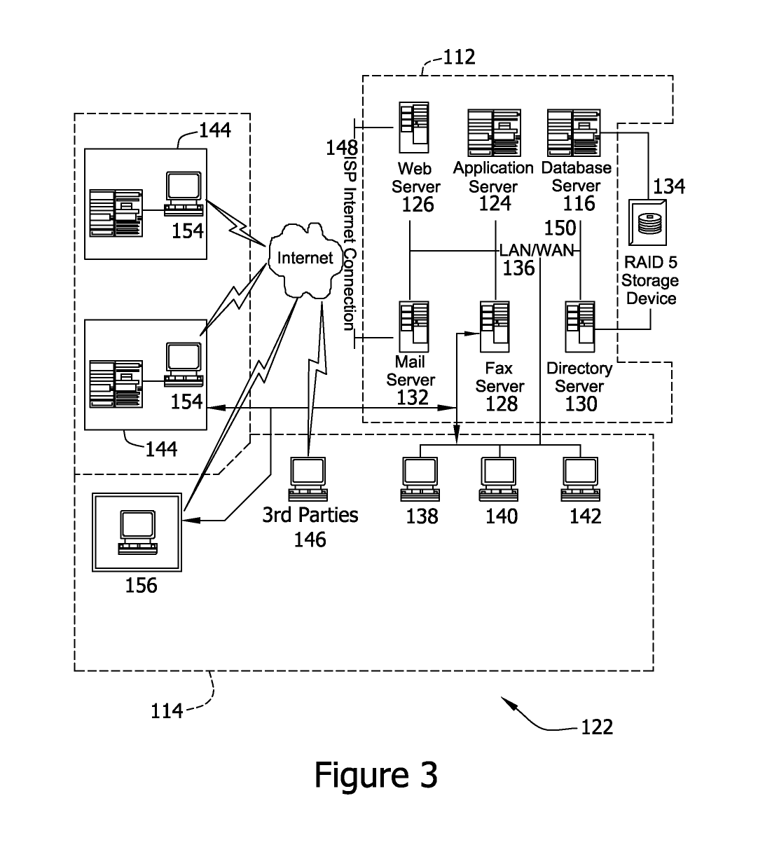

FIG. 3 is an expanded block diagram of an exemplary embodiment of a server architecture of a system 122. Components in system 122, identical to components of system 100 (shown in FIG. 2), are identified in FIG. 3 using the same reference numerals as used in FIG. 2. System 122 includes server system 112 and client systems 114. Server system 112 further includes database server 116, an application server 124, a web server 126, a fax server 128, a directory server 130, and a mail server 132. A disk storage unit 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an intranet.

In the exemplary embodiment, each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., pharmacies, clients, auditors, etc., 146 using an ISP Internet connection 148. The communication in the exemplary embodiment is illustrated as being performed using the Internet, however, any other wide area network (WAN) type communication can be utilized in other embodiments. The systems and processes are not limited to being practiced using the Internet. In addition, and rather than WAN 150, local area network 136 could be used in place of WAN 150.

In the exemplary embodiment, any authorized individual having a workstation 154 can access system 122. At least one of the client systems 114 includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 146 using a telephone link. Fax server 128 is configured to communicate with other client systems 138, 140, and 142 as well.

As used herein, the terms “software” and “firmware” are interchangeable, and include any computer program stored in memory for execution by personal computers, workstations, clients and servers, including RAM memory, ROM memory, EPROM memory, EEPROM memory, and non-volatile RAM (NVRAM) memory. The above memory types are exemplary only, and are thus not limiting as to the types of memory usable for storage of a computer program.

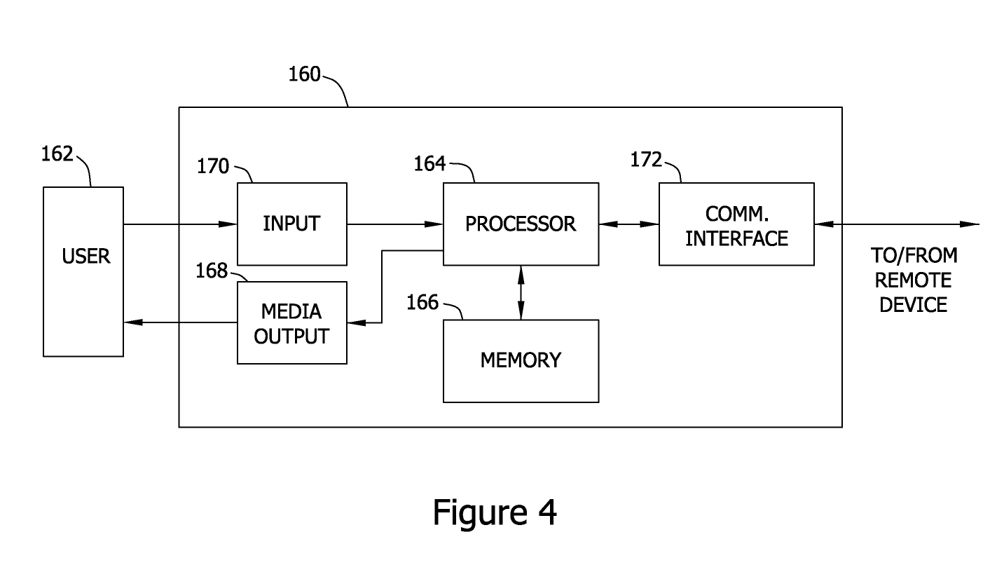

FIG. 4 illustrates an exemplary configuration of a user computer device 160 operated by a user 162. User computer device 160 may include, but is not limited to, client systems 114, 138, 140, and 142, workstation 154, and manager workstation 156 (shown in FIGS. 2 and 3).

User computer device 160 includes a processor 164 for executing instructions. In some embodiments, executable instructions are stored in a memory area 166. Processor 164 may include one or more processing units (e.g., in a multi-core configuration). Memory area 166 is any device allowing information such as executable instructions and/or transaction data to be stored and retrieved. Memory area 166 may include one or more computer readable media.

User computer device 160 also includes at least one media output component 168 for presenting information to user 162. Media output component 168 is any component capable of conveying information to user 162. In some embodiments, media output component 168 includes an output adapter (not shown) such as a video adapter and/or an audio adapter. An output adapter is operatively coupled to processor 164 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 168 is configured to present a graphical user interface (e.g., a web browser and/or a client application) to user 162. A graphical user interface may include, for example, a pharmacy interface for viewing and/or submitting prescription drug claims.

In some embodiments, user computer device 160 includes an input device 170 for receiving input from user 162. User 162 may use input device 170 to select and/or enter, without limitation, transaction data 28 (shown in FIG. 1). Input device 170 may include, but is not limited to, a keyboard, a pointing device, a mouse, a stylus, a touch sensitive panel (e.g., a touch pad or a touch screen), a bar code scanner, a magnetic strip reader, a gyroscope, an accelerometer, a position detector, a biometric input device, and/or an audio input device. A single component such as a touch screen may function as both an output device of media output component 168 and input device 170.

User computer device 160 may also include a communication interface 172, which is communicatively coupleable to a remote device such as server system 112 (shown in FIG. 2). Communication interface 172 may include, for example, a wired or wireless network adapter and/or a wireless data transceiver for use with a mobile telecommunications network.

Stored in memory area 166 are, for example, computer readable instructions for providing a user interface to user 162 via media output component 168 and, optionally, receiving and processing input from input device 170. A user interface may include, among other possibilities, a web browser and/or a client application. Web browsers enable users, such as user 162, to display and interact with media and other information typically embedded on a web page or a website from server system 112. A client application allows user 162 to interact with a server application of a pharmacy computer system, for example, server system 112.

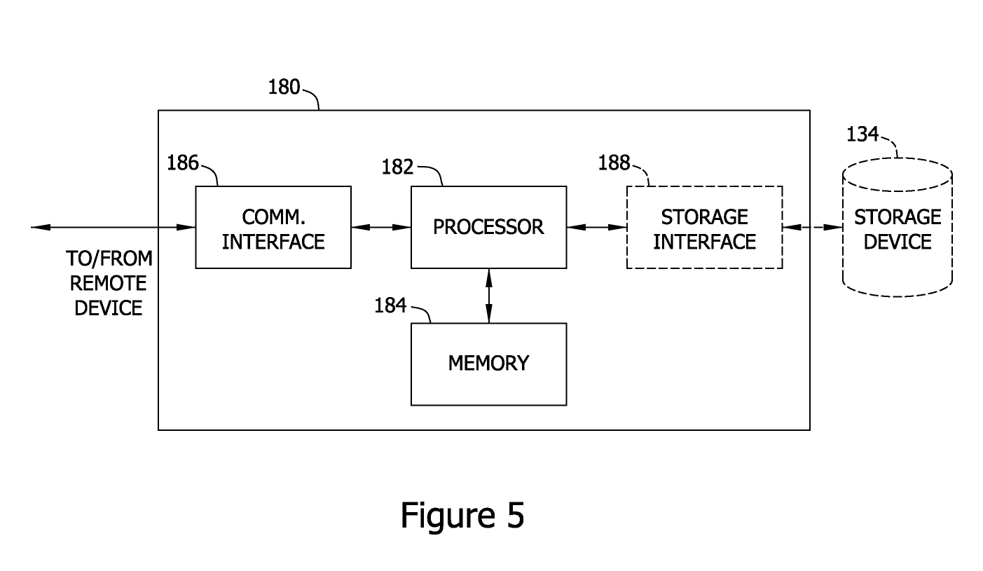

FIG. 5 illustrates an exemplary configuration of a server computer device 180 such as server system 112 (shown in FIG. 2). Server computer device 180 may include, but is not limited to, database server 116, application server 124, web server 126, fax server 128, directory server 130, and/or mail server 132.

Server computer device 180 also includes a processor 182 for executing instructions. Instructions may be stored in, for example, but not limited to, a memory area 184. Processor 182 may include one or more processing units (e.g., in a multi-core configuration).

Processor 182 is operatively coupled to a communication interface 186 such that server computer device 180 is capable of communicating with a remote device such as user computer device 160 (shown in FIG. 4) or another server computer device 180. For example, communication interface 186 may receive requests from user computer device 114 via the Internet, as illustrated in FIG. 3.

Processor 182 may also be operatively coupled to storage device 134. Storage device 134 is any computer-operated hardware suitable for storing and/or retrieving data, such as, but not limited to, data associated with database 120 (shown in FIG. 2). In some embodiments, storage device 134 is integrated within server computer device 180. For example, server computer device 180 may include one or more hard disk drives as storage device 134. In other embodiments, storage device 134 is external to server computer device 180 and may be accessed by a plurality of server computer devices 180. For example, storage device 134 may include multiple storage units such as hard disks and/or solid state disks in a redundant array of inexpensive disks (RAID) configuration. Storage device 134 may include a storage area network (SAN) and/or a network attached storage (NAS) system.

In some embodiments, processor 182 is operatively coupled to storage device 134 via a storage interface 188. Storage interface 188 is any component capable of providing processor 182 with access to storage device 134. Storage interface 188 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 182 with access to storage device 134.

A computer or computing device such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

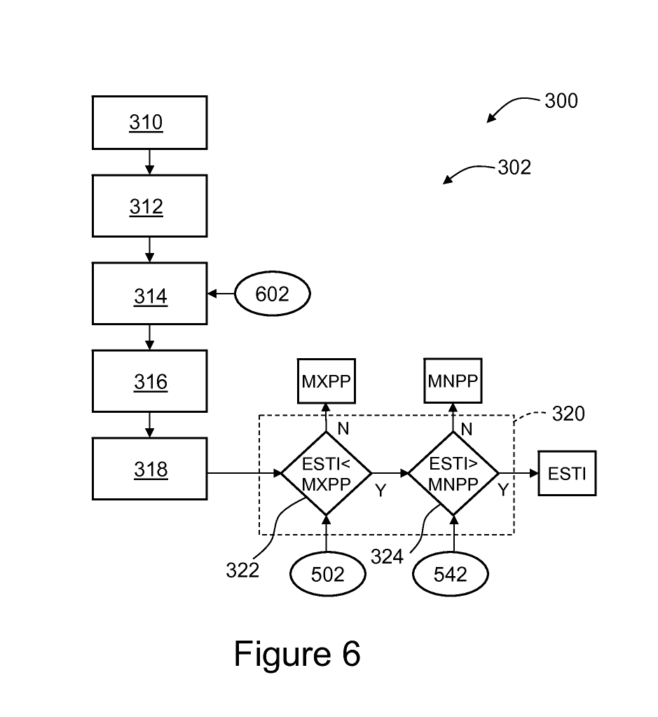

FIG. 6 is a block diagram 300 of an exemplary method 302 for determining an amount to pay a pharmacy, for example, pharmacy 22 (shown in FIG. 1) for a transaction, for example, transaction 12 (shown in FIG. 1). Method 302 facilitates managing a relationship between PBM 20 (shown in FIG. 1) and pharmacy 22. In the exemplary embodiment, method 302 is performed using server system 112 (shown in FIG. 2), and more specifically, server computer device 180 (shown in FIG. 5).

In the exemplary embodiment, method 302 includes receiving 310 transaction data, for example, transaction data 28 (shown in FIG. 1). For example, a pharmacist at pharmacy 22 may receive 310 consumer information, prescription drug benefit plan information, and prescription drug and dosage information, and enter the information into client system 114 (shown in FIG. 2). Consumer 26 is covered by a prescription drug benefit plan offered by client 24 who is a client of PBM 20. Consumer 26 requests that pharmacy 22 fill a prescription for a medication, for example, medication 14 (shown in FIG. 1). Method 302 further includes receiving 312 transaction data, for example, transaction data 30 (shown in FIG. 1), transmitted from pharmacy 22 to PBM 20. The transaction data received 312 at PBM 20 includes, but is not limited to, transaction data 28 and information identifying pharmacy 22.

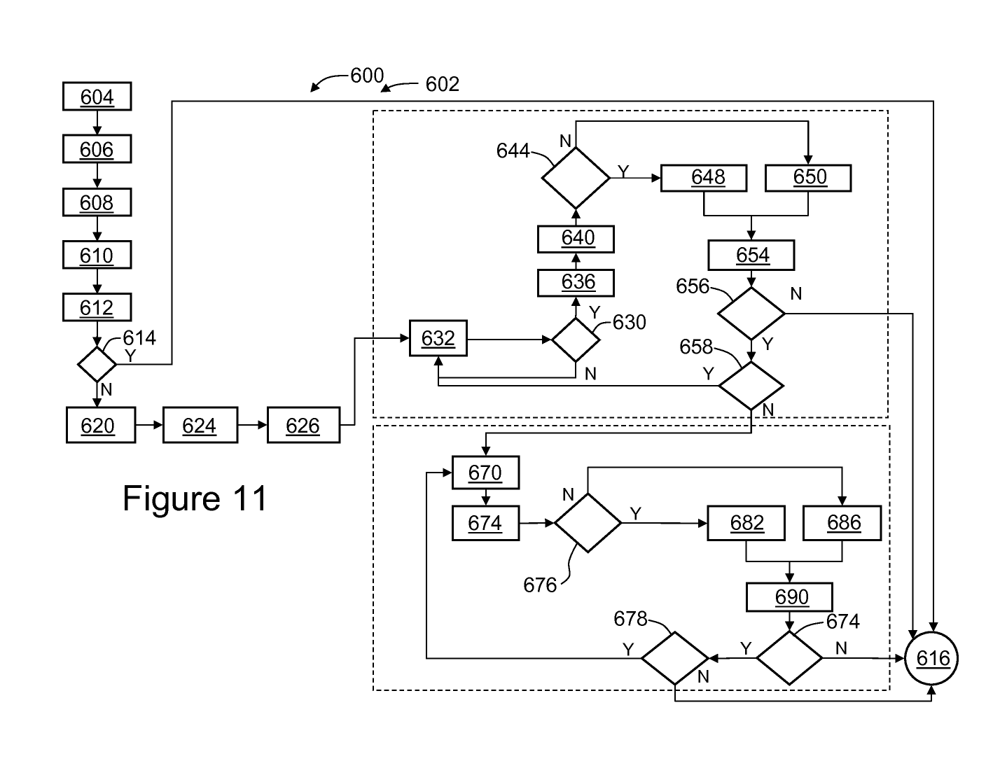

Method 302 also includes determining 314 a periodic pharmacy discount goal (PPDG) for pharmacy 22. The PPDG for pharmacy 22 may be determined 314 either after transaction 12 is initiated or after a previous transaction is completed in order to base each medication pricing calculation on up-to-date information. In the exemplary embodiment, server system 112 determines 314 the PPDG for pharmacy 22. Typically, by contract, PBM 20 and pharmacy 22 agree to a contractual pharmacy discount goal (CPDG). The CPDG is a percentage that is fixed contractually for a first predefined length of time, for example, a business quarter. Although described herein as a business quarter, the first predefined length of time may be a week, a month, a business or calendar year, and/or any other suitable length of time that allows server system 112 to function as described herein. For example, by contract, pharmacy 22 may agree to accept payments from PBM 20, of amounts set by PBM 20, for generic medications, so long as at the end of the business quarter, pharmacy 22 has been paid no less than AWP-x %, wherein x % is the CPDG and the AWP is a sum of the AWP for all generic medications sold in that business quarter. In contrast, the PPDG is a percentage that is updated periodically, for example, weekly. Although described herein as weekly, the PPDG may be updated hourly, daily, monthly, and/or after any other time period that allows server system 112 to function as described herein. The PPDG is determined 314 such that, based on past transaction information and predicted transaction information, the CPDG will be achieved at the end of the business quarter (see FIG. 11 for PPDG determining algorithm).

Although referred to herein as a singular entity, pharmacy 22 may include a group of pharmacies and/or a chain of pharmacies. A group of pharmacies has greater bargaining leverage when negotiating with PBM 20 and/or with drug wholesalers. Pharmacies may also be grouped together by PBM 20 in order to reduce the number of entities with which PBM 20 has contracts and manages transactions. For example, a pharmacy may not be a party to a contract with PBM 20 yet still receive a request from consumer 26 to fill a prescription and to utilize a prescription drug benefit plan managed by PBM 20. A pharmacy that is not a party to a contract with PBM 20 is referred to herein as an independent pharmacy. PBM 20 may group the independent pharmacies together into one or more groups of independent pharmacies, and manage the relationship with these independent pharmacies in much the same manner as they do with chain pharmacies. Typically these groups of independent pharmacies are generated based on a volume of prescription drug sales. There will not be a CPDG between the independent pharmacies and PBM 20, however, PBM 20 may designate a goal discount they desire to achieve when dealing with each group of independent pharmacies.

Method 302 further includes calculating 316 an actual pharmacy discount (PDA) for pharmacy 22. The PDA for pharmacy 22 may be calculated 316 either after transaction 12 is initiated or after a previous transaction is completed in order to base each medication pricing calculation on up-to-date information. In the exemplary embodiment, server system 112 calculates 316 the PDA for pharmacy 22 based on a total of pharmacy paid ingredient costs (PPIC) paid to pharmacy 22 for all generic drugs sold by pharmacy 22 in the current business quarter and the total AWP for those generic drugs. For example, the PDA for pharmacy 22 may be determined by:

$$P D A = 1 - ( \frac{ToDatePPIC}{ToDateAWP} ) ,$$

wherein ToDatePPIC is the total PPIC paid by PBM 20 to pharmacy 22 for generic drugs sold that quarter, and ToDateAWP is a sum of the AWP for those generic drugs. More specifically, PBM 20 may receive transaction data associated with a plurality of prescription drug transactions from pharmacy 22. The plurality of prescription drug transactions may include prescription drug transaction 12 and a second prescription drug transaction through an Nth prescription drug transaction. Calculating the ToDatePPIC, for a transaction N+1, includes calculating a total of the PPICs paid to pharmacy 22 for prescription drug transaction 12 through the Nth prescription drug transaction. Furthermore, PBM 20 may determine the ToDateAWP, for transaction N+1, by calculating the total of the AWP associated with prescription drug transaction 12 through the Nth prescription drug transaction.

The PDA is an up-to-date calculation of the current status of the overall discount that has been given to pharmacy 22, for a pool of generic drugs sold by pharmacy 22, thus far in the current business quarter. In some embodiments, PBM 20 excludes secondary payer claims and usual and customary claims from the PDA calculations, and other types of claims set forth in the contract between PBM 20 and pharmacy 22 may also be excluded from the PDA calculations.

Method 302 also includes calculating 318 an estimated discount (ESTD) to be given by PBM 20 to pharmacy 22 for transaction 12. The ESTD is calculated 318 at the time transaction 12 is initiated. Calculating 318 the ESTD for medication 14 associated with transaction 12 at the time transaction 12 is initiated is referred to herein as a “real-time” calculation of the ESTD. For example, server system 112 calculates 318 the ESTD for medication 14 needed to achieve the PPDG for pharmacy 22. In other words, an ESTD for consumer's 26 prescription for medication 14 is calculated that will adjust the PDA of pharmacy 22 to equal the PPDG for pharmacy 22. If the PDA is currently higher than the PPDG most recently determined 314, PBM 20 can lower the discount normally given for medication 14, in order to lower the PDA and approach the PPDG. In other words, since the most recent PPDG was determined 314, pharmacy 22 has been paid less than a minimum that PBM 20 has determined it should pay pharmacy 22 in order to achieve the CPDG at the end of the business quarter. PBM 20 will be paying pharmacy 22 more by lowering the discount on medication 14. Conversely, if the PDA is currently less than the most recently determined 314 PPDG, PBM 20 can increase the discount normally given for medication 14, in order to increase the PDA for pharmacy 22 and approach the PPDG. In other words, since the most recently determined 314 PPDG, pharmacy 22 has been paid more than a minimum that PBM 20 has determined it should pay pharmacy 22 in order to achieve the CPDG at the end of the business quarter. PBM 20 will be paying pharmacy 22 less than is typically paid for medication 14 by raising the discount on medication 14.

In the exemplary embodiment, the ESTD is based on the PPDG, the ToDateAWP, a ClaimAWP, and the ToDatePPIC. The ClaimAWP is a published price for medication 14. For example, the ESTD may be calculated 318 by:

$$ESTD = 1 - \frac{( ( 1 - PPDG ) ( ToDateAWP + ClaimAWP ) ) - ToDatePPIC}{ClaimAWP} .$$

Furthermore, an estimated pharmacy paid ingredient cost (ESTI) for medication 14 in transaction may be calculated by:

ESTI=((1−PPDG)(ToDateAWP+ClaimAWP))−ToDatePPIC.

Table 1 shows sample results determined using method 302. In the example, PBM 20 has paid pharmacy 22 $79,999 quarter to date for generic medications dispensed by pharmacy 22. A total AWP for those generic medications is $200,000. The PPDG for pharmacy 22 has been determined 314 to equal 60% and the AWP for medication 14 is $180. In the example shown in Table 1, pharmacy 22 has to-date been underpaid by PBM 20.

TABLE 1
PBM UNDERPAID PHARMACY
Actual Pharmacy Discount for given time period (PDA)

| | |
|---|---|
| Total Pharmacy Paid Ingredient Cost (generics) | $79,999 |
| Total Average Wholesale Price for those generics | $200,000 |
| PDA = | 60.0005% |

Calculating estimated discount (ESTD) - FIG. 6)

| | | |
|---|---|---|
| Periodic Pharmacy Discount Goal | PPDG | 60.0000% |
| Actual Pharmacy Discount | PDA | 60.0005% |
| Average Wholesale Price- to date | ToDateAWP | $200,000 |
| Average Wholesale Price- this claim | ClaimAWP | $180 |
| Pharmacy Paid Ingredient Cost- to date | ToDatePPIC | $79,999 |
| ESTD = | 59.4444% | |
| Estimated Pharmacy Paid Ingredient Cost = | ESTI | $73.00 |

Table 2 also shows sample results determined using method 302. In the example shown in Table 2, pharmacy 22 has been paid $80,005 quarter to date by PBM 20 for generic medications dispensed by pharmacy 22. Therefore, since the other variables provided in the example shown in Table 1 are unchanged, PBM 20 has to-date overpaid pharmacy 22.

TABLE 2
PBM OVERPAID PHARMACY
Actual Pharmacy Discount for given time period (PDA)

| | |
|---|---|
| Total Pharmacy Paid Ingredient Cost (generics) | $80,005 |
| Total Average Wholesale Price for those generics | $200,000 |
| PDA = | 59.9975% |

Calculating estimated discount (ESTD) - FIG. 6)

| | | |
|---|---|---|
| Periodic Pharmacy Discount Goal | PPDG | 60.0000% |
| Actual Pharmacy Discount | PDA | 59.9975% |
| Average Wholesale Price- to date | ToDateAWP | $200,000 |
| Average Wholesale Price- this claim | ClaimAWP | $180 |
| Pharmacy Paid Ingredient Cost- to date | ToDatePPIC | $80,005 |
| ESTD = | 62.7778% | |
| Estimated Pharmacy Paid Ingredient Cost = | ESTI | $67.00 |

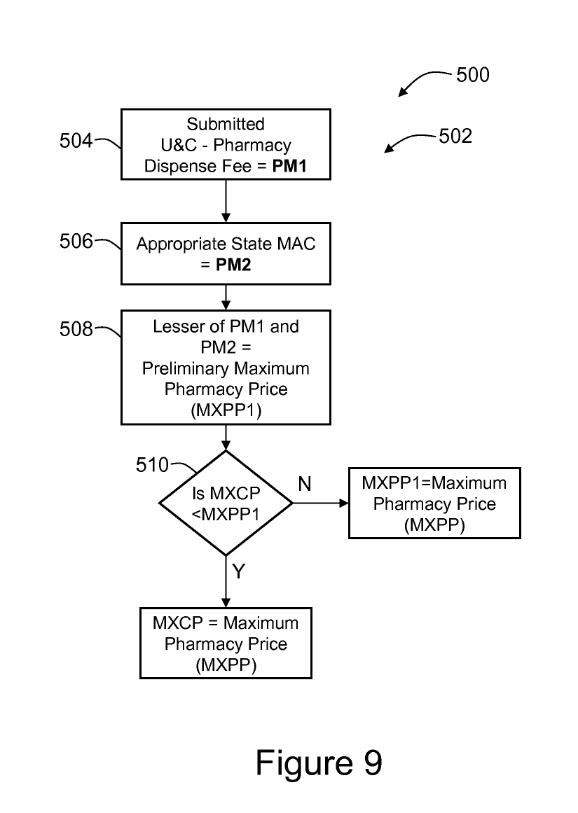

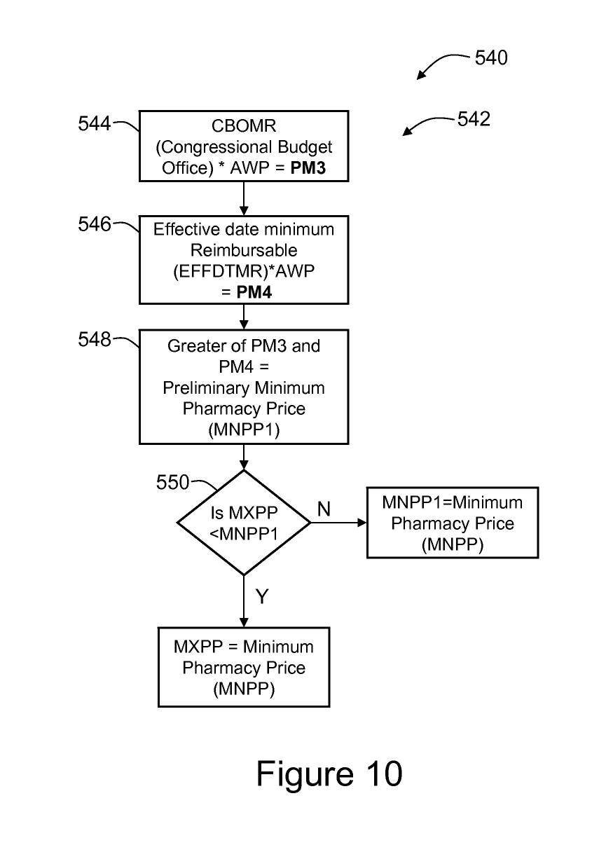

Method 302 also includes determining 320 a pharmacy paid ingredient cost (PPIC) for medication 14. The PPIC is the amount PBM 20 will pay pharmacy 22 for medication 14. Since the PPIC is based at least partially on the ESTD, the PPIC is also a real-time determination (i.e., determined for transaction 12 after transaction 12 is initiated). For example, server system 112 determines 320 what to pay pharmacy 22 for medication 14 based on a comparison of a maximum pharmacy paid amount (MXPP) (see FIG. 9) that PBM 20 will pay pharmacy 22, a minimum pharmacy paid amount (MNPP) (see FIG. 10) that PBM 20 will pay pharmacy 22, and the ESTI. Determining 320 includes determining 322 whether the ESTI is less than the MXPP. If the ESTI is greater than the MXPP, then PBM 20 pays pharmacy 22 the MXPP. In other words, the actual PPIC that PBM 20 transmits to pharmacy 22 will equal the MXPP. In this situation, the PPIC paid to pharmacy 22 would not be enough to adjust the PDA to equal the PPDG. However, determining 322 whether the ESTI is less than the MXPP facilitates preventing PBM 20 from paying pharmacy 22 more for medication 14 than PBM 20 determined it was willing to pay.

If the ESTI is less than the MXPP, determining 320 also includes determining 324 whether the ESTI is greater than the MNPP. If the ESTI is less than the MNPP, then pharmacy 22 is paid the MNPP. In other words, the actual pharmacy paid ingredient cost (PPIC) that PBM 20 transmits to pharmacy 22 will equal the MNPP. In this situation, the PPIC paid to pharmacy 22 would not be enough to adjust the PDA to equal the PPDG. However, determining 324 whether the ESTI is greater than the MNPP facilitates preventing PBM 20 from paying pharmacy 22 less than a minimum amount that PBM 20 determined was appropriate to pay pharmacy 22 for medication 14.

Finally, if the ESTI is greater than the MNPP, then PBM 20 will transmit an actual pharmacy paid ingredient cost (PPIC) to pharmacy 22 that equals the ESTI. After paying pharmacy 22 the ESTI, the PDA for pharmacy 22 will be substantially equal to the PPDG for pharmacy 22.

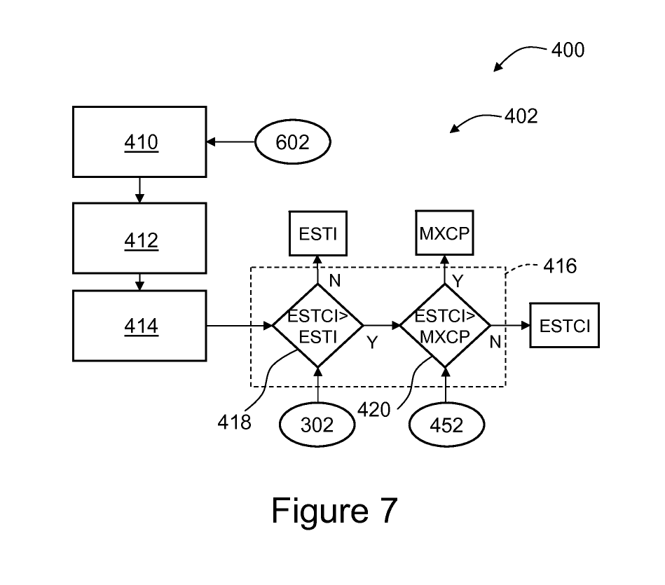

As described above, PBM 20 determines an amount to pay pharmacy 22 for a transaction initiated by a member of a group prescription drug benefit plan offered by client 24. FIG. 7 is a block diagram 400 of an exemplary method 402 for determining a client billed ingredient cost (CBIC) for medication 14. The CBIC is the amount PBM 20 will bill client 24 for medication 14 as provided to consumer 26 in transaction 12. Method 402 includes determining 410 a periodic client discount goal (PCDG) for client 24. For example, server system 112 determines 410 the PCDG for client 24. Typically, by contract, PBM 20 and client 24 agree to a contractual client discount goal (CCDG). The CCDG is a percentage that is fixed contractually for a first predefined length of time, for example, a business quarter. Although described herein as a business quarter, the first predefined length of time may be a week, a month, a business or calendar year, and/or any other length of time that allows server system 112 to function as described herein. For example, by contract, client 24 may agree to pay PBM 20 amounts set by PBM 20, for generic medications, so long as at the end of the business quarter, client 24 has paid no more than AWP-y %, wherein y % is the CCDG and the AWP is an average of the AWP for all generic medications purchased by members enrolled in the prescription drug benefit plan provided by client 24 in that business quarter. In contrast, the PCDG is a percentage that is updated periodically, for example, weekly. Although described herein as weekly, the PCDG may be updated hourly, daily, monthly, and/or after any other time period that allows server system 112 to function as described herein. The PCDG is determined 410 such that, based on past transaction information and predicted transaction information, that the CCDG will be achieved at the end of the business quarter (see FIG. 11 for PCDG determining algorithm).

Method 402 also includes calculating 412 an actual client discount (CDA) for client 24. The CDA is a running total of the discount currently given to client 24 by PBM 20. In the exemplary embodiment, server system 112 calculates 412 the CDA for client 24 based on a total of client billed ingredient costs (CBIC) billed to client 24 for all generic drugs purchased by members enrolled in the prescription drug benefit plan provided by client 24 and the total AWP for those generic drugs. For example, the CDA for client 24 may be determined by:

$$C D A = 1 - ( \frac{ToDateCBIC}{ToDateAWP} ) ,$$

wherein ToDateCBIC is the total CBIC billed by PBM 20 to client 24 for generic drugs sold that business quarter, and ToDateAWP is the sum of the AWP for those generic drugs. The CDA is an up-to-date calculation of the current status of the overall discount that has been given to client 24, for a pool of generic drugs purchased by members of the prescription drug benefit plan provided by client 24, in the current business quarter thus far. In some embodiments, PBM 20 excludes secondary payer claims and usual and customary claims from the CDA calculations, and other types of claims set forth in the contract between PBM 20 and client 24 may also be excluded from the CDA calculations.

Method 402 also includes calculating 414 an estimated discount (ESTCD) to be given by PBM 20 to client 24 for transaction 12. For example, server system 112 calculates 414 the ESTCD for medication 14 needed to achieve the PCDG for client 24 at the end of the business quarter. In other words, an ESTCD for medication 14 is calculated 414 that will adjust the CDA of client 24 to equal the PCDG for client 24. If the CDA is currently higher than the PCDG most recently determined 410, PBM 20 lowers the discount normally given for medication 14, in order to lower the CDA and approach the PCDG. In other words, since the most recently determined 410 PCDG, client 24 has been billed less than a minimum that PBM 20 has determined it should bill client 24 in order to achieve the CCDG at the end of the business quarter. PBM 20 will be billing client 24 more by lowering the discount on medication 14. Conversely, if the CDA is currently less than the most recently determined 410 PCDG, PBM 20 increases the discount normally given for medication 14, in order to increase the CDA and approach the PCDG. In other words, since the most recently determined 410 PCDG, client 24 has been billed more than a minimum that PBM 20 has determined it should bill client 24 in order to achieve the CCDG at the end of the business quarter. PBM 20 will be billing client 24 less than is typical for medication 14 by increasing the discount on medication 14.

In the exemplary embodiment, the ESTCD is based on the PCDG, the ToDateAWP, the ClaimAWP, and a ToDateCBIC. The ClaimAWP is a published price for medication 14. For example, the ESTCD may be calculated 414 by:

$$ESTCD = 1 - \frac{( ( 1 - PCDG ) ( ToDateAWP + ClaimAWP ) ) - ToDateCBIC}{ClaimAWP} .$$

Furthermore, an estimated client billed ingredient cost (ESTCI) for this transaction may be calculated by:

ESTCI=((1−PCDG)(ToDateAWP+ClaimAWP))−ToDateCBIC.

Table 3 shows sample results determined using method 402. In the example shown in Table 3, client 24 has been billed $83,998 quarter to date by PBM 20 for generic medications purchased by members of the prescription drug benefit plan offered by client 24. A total AWP for those generic medications is $200,000. The PCDG for client 24 has been determined 410 to be 58% and the AWP for medication 14 is $180. In the example shown in Table 3, client 24 has to-date been under billed by PBM 20.

TABLE 3
PBM UNDER BILLED CLIENT
Actual Client Discount for given time period (CDA)

| | |
|---|---|
| Total Client Billed Ingredient Cost (generics) | $83,998 |
| Total Average Wholesale Price for those generics | $200,000 |
| CDA = | 58.0010% |

Calculating estimated discount (ESTCD) - FIG. 9)

| | | |
|---|---|---|
| Periodic Client Discount Goal | PCDG | 58.0000% |
| Actual Client Discount | CDA | 58.0010% |
| Average Wholesale Price- to date | ToDateAWP | $200,000 |
| Average Wholesale Price- this claim | ClaimAWP | $180 |
| Client Billed Ingredient Cost- to date | ToDateCBIC | $83,998 |
| ESTCD = | 56.8889% | |
| Estimated Client Billed Ingredient Cost = | ESTCI | $77.60 |

Table 4 also shows sample results determined using method 402. In the example shown in Table 4, client 24 has been billed $84,004 quarter to date by PBM 20 for generic medications purchased by members of the prescription drug benefit plan offered by client 24. The other variables provided in the example shown in Table 3 are unchanged. In the example shown in Table 4, PBM 20 has to-date over billed client 24.

TABLE 4
PBM OVER BILLED CLIENT
Actual Client Discount for given time period (CDA)

| | |
|---|---|
| Total Client Billed Ingredient Cost (generics) | $84,004 |
| Total Average Wholesale Price for those generics | $200,000 |
| CDA = | 57.9980% |

Calculating estimated discount (ESTCD) - FIG. 9)

| | | |
|---|---|---|
| Periodic Client Discount Goal | PCDG | 58.0000% |
| Actual Client Discount | CDA | 57.9980% |
| Average Wholesale Price- to date | ToDateAWP | $200,000 |
| Average Wholesale Price- this claim | ClaimAWP | $180 |
| Client Billed Ingredient Cost- to date | ToDateCBIC | $84,004 |
| ESTCD = | 60.2222% | |
| Estimated Client Billed Ingredient Cost = | ESTCI | $71.60 |

Method 402 also includes determining 416 the CBIC to bill client 24 for medication 14 involved in transaction 12. For example, server system 112 determines 416 what to bill client 24 for medication 14 based on a comparison of the ESTI (shown in FIG. 6) and the ESTCI. Determining 416 includes determining 418 whether the ESTCI is greater than the ESTI. If the ESTCI is less than the ESTI, then client 24 is billed the ESTI. In other words, the actual client billed ingredient cost (CBIC) that PBM 20 bills to client 24 will equal the ESTI. This ensures that PBM 20 is at least reimbursed the estimated pharmacy paid ingredient cost (ESTI) used to determine the amount to pay pharmacy 22.

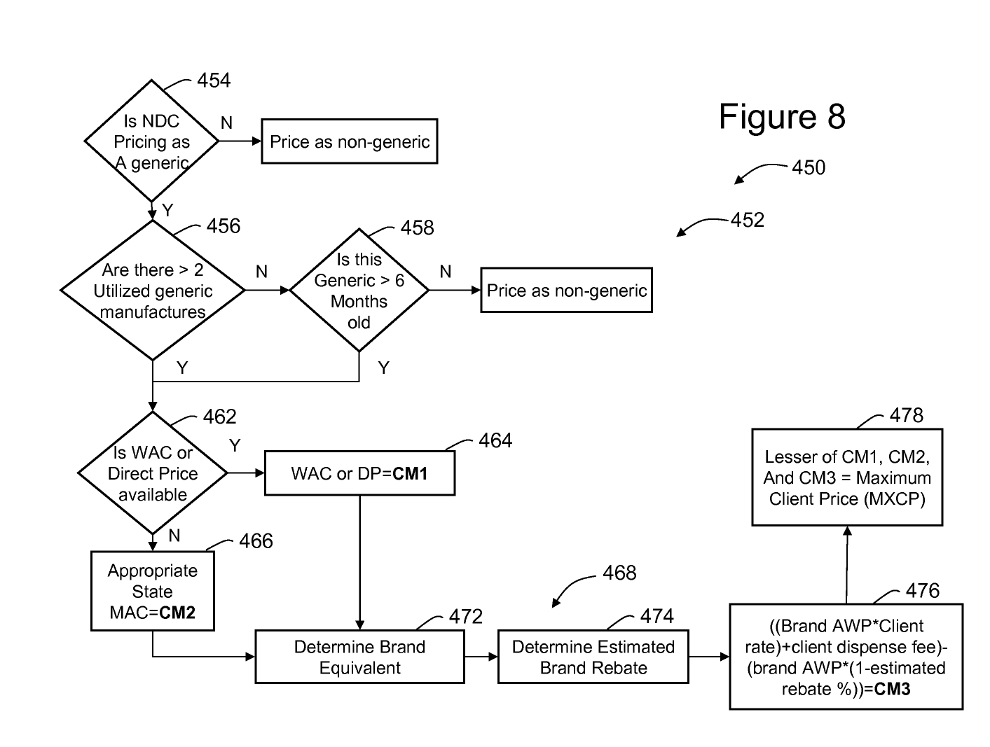

If the ESTCI is greater than the ESTI, determining 416 also includes determining 420 whether the ESTCI is greater than a maximum client billed amount (MXCP) (shown in FIG. 8). The MXCP is a maximum amount that PBM 20 will bill client 24 for medication 14. The MXCP is determined based on, for example, a number of manufacturers producing medication 14, an age of medication 14, a wholesale acquisition cost (WAC) or direct price of medication 14, and a state-specific MAC price for medication 14. If the ESTCI is less than the MXCP, then client 24 is billed the ESTCI. In other words, the actual client billed ingredient cost (CBIC) that PBM 20 bills client 24 will be equal to the ESTCI. If client 24 is billed the ESTCI, the CDA for client 24 will be substantially equal to the PCDG for client 24 after transaction 12 is complete. If the ESTCI is greater than the MXCP, then the actual client billed ingredient cost (CBIC) PBM 20 bills to client 24 equals the MXCP, defined above and determined (shown in FIG. 8) to be the maximum amount PBM 20 will bill client 24 for medication 14. This maximizes the reimbursement paid to PBM 20 while maintaining the actual client billed ingredient cost (CBIC) within a range predetermined by PBM 20 to be acceptable to client 24.

FIG. 8 is a block diagram 450 of an exemplary method 452 for determining a maximum amount to bill client 24 (shown in FIG. 1) for transaction 12 (shown in FIG. 1). For example, server system 112 (shown in FIG. 2) may determine the maximum client billed amount (MXCP) for medication 14. Method 452 includes determining 454 whether the National Drug Code (NDC) has priced medication 14 as a generic drug. If the NDC is not pricing medication 14 as a generic drug, then client 24 is billed a client billed ingredient cost equal to a non-generic price determined using known methods of pricing brand-name medications. If the NDC is pricing medication 14 as a generic drug, method 452 also includes determining 456 a number of manufacturers that are producing medication 14 and determining 458 an age of medication 14 if less than a predefined number of manufacturers are producing medication 14. For example, if the number of manufacturers producing medication 14 is less than the predefined number, for example, three manufacturers, and medication 14 has been manufactured as a generic drug for less than a second predefined length of time (e.g., less than a predefined number of months), client 24 is billed a client billed ingredient cost equal to an amount set for a non-generic equivalent of medication 14 using known methods of pricing brand-name medications.

More specifically, if the number of manufacturers producing medication 14 is less than the predefined number, and the age of medication 14 is less than the second predefined length of time, client 24 is billed a client billed ingredient cost equal to the lesser of a usual and customary price set by pharmacy 22 for medication 14 or the AWP-x %. For example, x % (i.e., the pharmacy discount) is determined by the contract. In other words, medication 14 is priced as a non-MAC drug would typically be priced. By only pricing drugs as non-generic that are manufactured by few manufacturers, and have been manufactured as a generic for less than the second predefined length of time, older drugs are not priced as non-generic even though they may be produced by a small number of manufacturers. This prevents billing client 24 a non-generic price, which is typically higher than a generic price, for a medication that has been generically available on the market for a relatively long period of time, even though only a small number of manufactures choose to produce the medication. However, client 24 is billed a premium amount for generic drugs that are produced by a small number of manufacturers and are new to the generic market.

Method 452 further includes determining 462 if a wholesale acquisition cost (WAC) or a direct price is available. WAC and direct prices are benchmark prices, published and publicly available on a consistent basis. For example, if server system 112 determines 462 that a WAC and/or a direct price is available, method 452 includes determining 464 a first client maximum amount (CM1). If available, CM1 is equal to the WAC adjusted by a predetermined multiplier. If the WAC is not available, CM1 is equal to the direct price adjusted by a predetermined multiplier. If server system 112 determines 462 that neither a WAC nor a direct price is available, method 452 further includes determining 466 a second client maximum amount (CM2). The CM2 is equal to a state-specific MAC for medication 14, adjusted by a predetermined multiplier. State-specific MAC lists are publicly available lists of drug prices.

Method 452 further includes determining 468 a third client maximum amount (CM3). Determining 468 CM3 includes determining 472 a brand equivalent for medication 14 and estimating 474 a brand rebate (e.g., an estimated brand rebate percentage, EBR) for the brand equivalent. In the exemplary embodiment, determining 468 further includes calculating 476 CM3 based on a published brand AWP for the brand equivalent, the PCDG, a client dispense fee (CDF), and the EBR for the brand equivalent. For example, CM3 may be calculated 476 by: CM3=(BrandAWP*PCDG)+CDF−(BrandAWP*(1−EBR)).

Method 452 further includes determining 478 the MXCP. In the exemplary embodiment, the MXCP is the lesser of CM1, CM2, and CM3, and server system 112 applies the MXCP determined using method 452 to method 402 (shown in FIG. 7).

FIG. 9 is a block diagram 500 of an exemplary method 502 for determining the maximum pharmacy paid amount (MXPP) PBM 20 (shown in FIG. 1) will pay pharmacy 22 (shown in FIG. 1) for medication 14 (shown in FIG. 1) involved in transaction 12 (shown in FIG. 1). Method 502 includes determining 504 a first maximum pharmacy amount (PM1) based on a usual and customary price set by pharmacy 22. In the exemplary embodiment, PM1 equals the usual and customary price minus a pharmacy dispense fee. Typically, the pharmacy dispense fee is fixed in the contract between PBM 20 and pharmacy 22.

Method 502 also includes determining 506 a second maximum pharmacy amount (PM2). In the exemplary embodiment, PM2 is based on a MAC price published in, for example, a state-specific publication. Method 502 also includes determining 508 a preliminary maximum pharmacy paid price (MXPP1). The MXPP1 equals the lesser of PM1 and PM2.

Method 502 also includes comparing 510 the MXPP1 to the MXCP (shown in FIG. 8). If the MXPP1 is less than the MXCP, the MXPP is selected to equal the MXPP1. In other words, if the maximum client billing price (MXCP) is greater than the preliminary maximum pharmacy paid price, then the maximum PBM 20 will pay pharmacy 22 will equal the MXPP1. Conversely, if the preliminary maximum pharmacy paid price (MXPP1) is greater than the maximum client billing price (MXCP), the maximum amount (MXPP) PBM 20 will pay pharmacy 22 will equal the maximum PBM 20 will bill client 24 (MXCP). This ensures that the maximum PBM 20 will pay pharmacy 22 is not higher than the maximum PBM 20 can bill client 24. Furthermore, the maximum PBM 20 will pay pharmacy 22 (MXPP) equals the minimum (MNCP) PBM 20 will bill client 24. In the exemplary embodiment, server system 112 applies the MXPP determined using method 502 to method 302 (shown in FIG. 6).

FIG. 10 is a block diagram 540 of an exemplary method 542 for determining a minimum pharmacy paid amount (MNPP) that PBM 20 will pay pharmacy 22 for medication 14 (shown in FIG. 1) associated with transaction 12 (shown in FIG. 1). Method 542 includes determining 544 a third maximum pharmacy amount (PM3). PM3 is determined 544 based on data from the United States Congressional Budget Office and a number of manufacturers that produce medication 14. Method 542 further includes determining 546 a fourth maximum pharmacy amount (PM4), which is based on a prior years effective discount for drugs of similar age. Method 542 also includes comparing 548 PM3 and PM4 to determine a preliminary minimum pharmacy price (MNPP1).

Method 542 also includes comparing 550 the maximum pharmacy paid price (i.e., MXPP, shown in FIG. 9) and the MNPP1. For example, if server system 112 determines that the maximum PBM 20 will pay pharmacy 22 (i.e., the MXPP) for medication 14 is less than MNPP1, then server system 112 sets the MNPP equal to the MXPP. In other words, if the maximum amount PBM 20 will pay pharmacy 22, based on PM1 and PM2, is less than a minimum amount PBM 20 will pay pharmacy 22, based on PM3 and PM4, server system 112 sets the minimum PBM 20 will pay pharmacy 22 to equal the MXPP. If the MXPP is greater than the MNPP1, then the minimum pharmacy 22 will be paid equals the MNPP1. This ensures that the minimum pharmacy 22 will be paid is the lesser of the MXPP and the MNPP1. In the exemplary embodiment, server system 112 applies the MNPP determined using method 542 to method 302 (shown in FIG. 6).

FIG. 11 is a block diagram 600 of an exemplary method 602 for determining the periodic pharmacy discount goal (PPDG) applied to the method shown in FIG. 6 and the periodic client discount goal (PCDG) applied to the method shown in FIG. 7. Unlike methods 302, 402, 452, 502, and 542, described above, method 602 is not applied to an individual claim or transaction, rather, method 602 provides a periodic adjustment to a pharmacy discount goal and/or a client discount goal.

In the exemplary embodiment, the PCDG and the PPDG are periodically adjusted to ensure the CCDG and the CPDG are achieved at the end of the business quarter. As described above, the pharmacy paid ingredient cost and the client billed ingredient cost are calculated for a transaction such that the CCDG and CPDG are achieved. Method 602 provides additional compensation in order to achieve the contracted goals. Method 602 may be used with, or separately from, the methods described above. Method 602 includes calculating 604 a change in the price/claim PBM 20 is billing a client (e.g., client 24) that would cause the actual client discount (CDA) for client 24 to reach the contractual client discount (CCDG). Method 602 also includes calculating 606 an updated PCDG based on a price/claim adjusted by the calculated 604 amount. By applying the calculated 606 PCDG to upcoming transactions, the CDA of client 24 will move toward the CCDG given expectations for the upcoming week. Although described herein as an upcoming week, method 602 may perform calculations based on expectations for any upcoming period of time including, but not limited to, an upcoming day, week, or month.

In the exemplary embodiment, method 602 also includes calculating 608 a change in the price/claim PBM 20 is paying a pharmacy (e.g., pharmacy 22) that would cause the actual pharmacy discount (PDA) for pharmacy 22 to reach the contractual pharmacy discount (CPDG). Method 602 also includes calculating 610 an updated PPDG based on a price/claim adjusted by the calculated 608 amount. By applying the calculated 610 PPDG to upcoming transactions, the PDA of pharmacy 22 will move toward the CPDG given expectations over the upcoming week.

Furthermore, method 602 facilitates determining which part of the book of business of PBM 20 is causing the most variance from a predefined goal (e.g., internal financial goals of PBM 20), and therefore, may provide the largest opportunity for adjustments in order to reduce the variance. By updating goals throughout the business quarter, system 112 is able to keep PBM 20 on track to achieve internal financial goals and to meet contractually agreed upon guarantees. Adjustment of goals throughout the business quarter allows PBM 20 to compensate for unexpected changes in circumstances of PBM 20, pharmacy 22, and/or client 24. Adjustment of goals throughout the business quarter also allows PBM 20 to compensate for deviations from expected benefit plan usage. For example, new activities by client 24 or pharmacy 22 may necessitate a change in goals. Client 24 might acquire another company and that company might include employees who are known to use less than an average quantity of generic drugs. That acquisition might significantly change the generic fill rate for client 24 and necessitate a change in the periodic client discount goal (PCDG) for client 24 in order to achieve the contractual client discount goal (CCDG) at the end of the business quarter.

In the exemplary embodiment, method 602 includes determining 612 an overall cost of sales (COS) achieved by PBM 20 (shown in FIG. 1). For example, server system 112 (shown in FIG. 2) may determine the COS year to date (YTD). COS YTD may be based on a total amount paid to pharmacies (e.g., pharmacy paid ingredient cost to date (TotalPPIC) and pharmacy dispense fees) and a total amount billed to clients (e.g., client billed ingredient cost to date (TotalCBIC) and client dispense fees). For example, COS YTD may be determined by:

$$COSYTD = \frac{TotalPPIC + TotalPharmacyDispenseFee}{TotalCBIC + TotalClientDispenseFee} .$$

Although described herein as determining 612 the COS YTD, method 602 may also include determining a COS quarter to date (QTD), a COS month to date (MTD), or a COS for any other time period that allows server system 112 to function as described herein. Method 602 also includes determining 614 if the COS YTD is within a predefined range of a predefined goal (e.g., a cost of service goal for PBM 20, COSG). In the exemplary embodiment, the COSG is a preliminary goal/assumption stored in a database, for example, database 120 (shown in FIG. 2) for use by server system 112. For example, server system 112 may determine 614 if the COS YTD is between the COSG and the COSG+z %, wherein z % is the predefined range. If the COS YTD is within the predefined range of the COSG, method 602 ends 616. No further adjustments to the PPDG or PCDG are needed since the COS YTD is within an acceptable range of the COSG.

A value input into server system 112 is an expected pharmacy paid ingredient cost (ExpectedPaid) for the upcoming week. If the COS YTD is not within the predefined range of the COSG, method 602 also includes calculating 620 a client billed variance. The client billed variance is a difference between a client billed ingredient cost calculated by applying the COSG to the ExpectedPaid and a client billed ingredient cost calculated by applying the COS YTD to the ExpectedPaid. For example, PBM 20 calculates an amount (ExpectedBilled) that should be billed to the clients over the upcoming week to achieve the COSG based on the ExpectedPaid. The ExpectedBilled may be calculated by:

$$ExpectedBilled = \frac{TotalPPIC + ExpectedPaid}{COSG} - TotalCBIC .$$

An adjusted COS Goal (COSGN) may also be calculated, for example, by:

$$COSGN = \frac{ExpectedPaid}{( \frac{TotalPPIC + ExpectedPaid}{COSG} ) - TotalCBIC} .$$

The COSGN is a goal for the upcoming week. If the COSGN is achieved over the week, at the end of the week the COS YTD will equal the COSG.

To determine where in the business of PBM 20 adjustments may be made to advance the COS YTD closer to the COSG, method 602 includes determining 624 at least one metric against preset goals for each group managed by PBM 20. For example, server system 112 may determine 624 performance metrics against the preset goals for each pharmacy 22 doing business with PBM 20 and/or for each client 24 whose prescription drug benefit plan is managed by PBM 20. The performance metrics allow server system 112 to determine what is causing the variance between the COS YTD and the COSG. The metrics compare, for example, but not limited to: (1) a client billed goal to actual client billings; (2) an overall cost/claim goal to actual overall cost/claim; (3) a generic cost/claim goal to actual generic cost/claim; (4) a brand cost/claim to actual brand cost/claim; and/or (5) a generic fill rate (GFR) goal to actual GFR.

Method 602 also includes rank ordering 626 the groups based on a score determined for each group based on the performance metrics. For example, server system 112 may assign a relevance number to each of the performance metrics. The relevance number indicates the level of importance placed on the corresponding performance metric. Each relevance number may be a percentage that is multiplied by the corresponding performance metric, wherein the percentages, in sum, equal 100%. The performance metrics, adjusted by relevance numbers, are totaled to obtain a score for each group. Server system 112 rank orders 626 the groups based on these scores. Server system 112 uses these scores to determine an order in which to adjust the goals. In the exemplary embodiment, server system 112 will first adjust the clients, starting with the client with the greatest affect on the variance (i.e., the highest score), then move on to the pharmacy with the highest influence on the variance.

For example, server system 112 rank orders 626 the clients, and client 24 is determined to have the greatest influence on variance. Server system 112 then determines whether the COS YTD for client 24 is less than a predefined COS YTD goal for client 24 (COSG_{C}). In other words, server system 112 determines if client 24 is negatively affecting the variance of PBM 20. If client 24 is positively affecting variance, the PCDG for client 24 will not be changed, and method 602 includes selecting 632 the client with the next highest influence on variance.

If client 24 has had a negative affect on variance (i.e., the COS YTD for client 24 is less than COSG_{C}), method 602 also includes calculating 636 a variance per claim for client 24. For example, server system 112 may calculate 636 the variance per claim for client 24. Calculating 636 may include calculating an overall variance per claim for client 24, a variance per claim for all brand drugs sold to members of the prescription drug benefit plan provided by client 24, and/or a variance per claim for all generic drugs sold to members of the prescription drug benefit plan provided by client 24. Calculating 636 allows server system 112 to determine more specifically how client 24 is negatively affecting variance and what changes may be made to prevent client 24 from further negatively affecting the variance or to positively affect the variance.

Method 602 also includes calculating 640 an amount that PBM 20 would have to raise the price/claim billed to client 24 for generic medications in order for the COS YTD for PBM 20 to reach the COSG. For client 24, server system 112 may calculate 640 the amount to raise the generic price/claim based on a total of pharmacy paid ingredient costs paid by PBM 20 to all pharmacies to date (PharmPaid), and a total of pharmacy paid ingredient costs expected to be paid during the upcoming week (ExpPharmPaid), for claims submitted by members of the prescription medication plan of client 24. The amount to raise the generic price/claim may also be based on the COSG for client 24, an actual number of claims submitted to PBM 20 associated with client 24 (ActualClaims_{C}), an expected number of claims for the upcoming time period (ExpClaims_{C}), and a current generic cost per claim (GCPC_{C}) for client 24. For example:

$$Δ price \text{/} claim = \frac{\frac{PharmPaid + ExpPharmPaid}{COSG}}{{ActualClaims}_{C} + {ExpClaims}_{C}} - {GCPC}_{C} .$$

Method 602 further includes determining 644 if the increase to the generic price/claim billed to client 24 (Δprice/claim) is below a predefined threshold. In the exemplary embodiment, the predefined threshold is stored in database 120 and is a threshold determined to ensure that the price/claim increase is below a level that would dramatically increase bills transmitted to client 24. In the exemplary embodiment, changes to the price/claim billed to client 24 are designed such that COS YTD gradually approaches COSG.

If the increase to the price/claim billed to client 24 is below the predefined threshold, server system 112 calculates 648 a new periodic client discount goal (PCDG) that will raise the price/claim billed by PBM 20 by the amount calculated 640 by server system 112. If the increase to the price/claim billed to client 24 is above the predefined threshold, server system 112 calculates 650 a new periodic client discount goal (PCDG) that will raise the price/claim billed by the predefined threshold amount. This increase allows PBM 20 to increase the PCDG for client 24 by the maximum amount allowable before the predefined threshold increase is exceeded.

Method 602 also includes calculating 654 a remaining amount of variance. For example, server system 112 calculates 654 an amount that must be raised by PBM 20 in order to achieve the COSG at the end of the business quarter. The remaining variance may be calculated 654 based on the previously determined remaining variance and the affect changes to the PCDG are expected to have on the variance over the upcoming week.

Server system 112 determines 656 if the remaining amount of variance is greater than zero. If the remaining variance is greater than zero (i.e., a variance between COS YTD and COSG still remains), server system 112 determines 658 if any other clients remain on the list of clients affecting the variance. If there are clients remaining, server system 112 again selects 632 the client with the next largest affect on variance. If the remaining variance is zero, the program ends 616.

If the remaining variance is greater than zero, and there are no additional clients on the list of clients influencing variance, server system 112 identifies 670 a pharmacy, for example, pharmacy 22 with the largest affect on variance. In the exemplary embodiment, server system 112 identifies a tier, chain, or other grouping of pharmacies that has the largest affect on variance. Pharmacy 22 is negatively affecting variance with respect to PBM 20 when PBM 20 has paid pharmacy 22 more than was guaranteed by contract. Therefore, to positively affect the variance, server system 112 will determine a new, higher periodic pharmacy discount goal (PPDG), in order to pay less to pharmacy 22 for upcoming transactions.

In the exemplary embodiment, server system 112 calculates 674 an amount that PBM 20 would have to lower the generic price/claim they are paying pharmacy 22 in order to achieve the COSG. As described above, the COSG may be stored in database 120 for use by server system 112. Method 602 also includes determining 676 if the reduction to the generic price/claim paid to pharmacy 22 is within a predefined threshold, which also is stored in database 120 for use by server system 112. If the reduction to the generic price/claim paid to pharmacy 22 is within the predefined threshold, server system 112 calculates 682 a new periodic pharmacy discount goal (PPDG) based at least partially on the reduced price/claim. If the reduction to the price/claim paid to pharmacy 22 is not within the predefined threshold, server system 112 calculates 686 a new periodic pharmacy discount goal (PPDG) based on the old price/claim reduced by the predefined threshold amount. This ensures that the new PPDG is increased either by an amount that will increase the COS YTD to the COSG, or will increase the COS YTD by the largest amount possible without changing the price/claim paid to pharmacy 22 more than the predefined amount. The predefined threshold is initially set by PBM 20 at a level that facilitates preventing sudden large changes in the price/claim paid to pharmacy 22.

Once the new PPDG for pharmacy 22 is calculated 682 or 686, method 602 includes calculating 690 a remaining amount of variance. For example, server system 112 calculates 690 the remaining amount of variance between COS YTD and COSG based at least partially on assumptions of the number and types of claims that pharmacy 22 will submit to PBM 20 over the remainder of the business quarter. Server system 112 then determines 674 if the remaining amount of variance is greater than zero. If the remaining variance is greater than zero, server system 112 determines 678 if any other tiers, chains, and/or other groupings of pharmacies remain on the list of pharmacies affecting variance. If there are pharmacies remaining, server system 112 again identifies 670 the pharmacy having the next greatest affect on variance. If the remaining variance is zero, or there are no pharmacies remaining, the program ends 616.

As described herein, computers, for example, user computer device 160 (shown in FIG. 4) and/or server computer device 180 (shown in FIG. 5), may operate in a networked environment using logical connections to one or more remote computers. Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for managing a prescription benefit plan, including determining an amount to pay a pharmacy and an amount to bill a client on a per transaction basis. The embodiments illustrated and described herein facilitate using current values to determine the amount to pay the pharmacy and the amount to bill the client, resulting in more accurate determinations and maintaining a close proximity to preset goals. For example, the embodiments described herein receive and store pharmacy paid ingredient costs, AWP associated with medications included in transactions managed by the PBM, and client billed ingredient costs to facilitate up-to-date calculations of a total of pharmacy paid ingredient costs, a total of the associated AWP, and a total of the client billed ingredient costs. Furthermore, a determination of a pharmacy paid ingredient cost is determined in real-time, using the results of the up-to-date calculations, after a prescription drug transaction is initiated by an individual with the pharmacy.

The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects of the invention.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for managing payments between a prescription drug benefits manager (PBM), a pharmacy, and a client of the PBM, the payments made in accordance with a prescription drug benefits plan offered by the client to an individual and managed by the PBM, said method comprising:
receiving transaction data associated with a first prescription drug transaction from the pharmacy, the transaction data including data identifying the prescription drug benefits plan and data identifying a first medication and a dosage of the first medication;
determining at least one of a pharmacy discount goal and a client discount goal; and
determining at least one of an actual pharmacy discount provided by the PBM to the pharmacy over a predefined period of time, and an actual client discount provided by the PBM to the client over the predefined period of time.

2. A method in accordance with claim 1, further comprising determining at least one of a pharmacy paid ingredient cost for the first prescription drug transaction and a client billed ingredient cost for the first prescription drug transaction, wherein the pharmacy paid ingredient cost is an amount paid by the PBM for reimbursing the pharmacy for performing the first prescription drug transaction, the pharmacy paid ingredient cost based at least partially on the pharmacy discount goal and the actual pharmacy discount, and wherein the client billed ingredient cost is an amount billed by the PBM to reimburse the PBM for performing the first prescription drug transaction, the client billed ingredient cost based at least partially on the client discount goal and the actual client discount.

3. A method in accordance with claim 2, wherein determining the pharmacy paid ingredient cost comprises determining in real-time an estimated pharmacy paid ingredient cost that if applied to the first prescription drug transaction will adjust the actual pharmacy discount to equal the pharmacy discount goal.

4. A method in accordance with claim 2, wherein determining the pharmacy paid ingredient cost further comprises determining a maximum pharmacy paid amount and a minimum pharmacy paid amount.

5. A method in accordance with claim 4, further comprising:
transmitting the maximum pharmacy paid amount to the pharmacy if the estimated pharmacy paid ingredient cost is greater than the maximum pharmacy paid amount;
transmitting the minimum pharmacy paid amount if the estimated pharmacy paid ingredient cost is less than the minimum pharmacy paid amount; and
transmitting the estimated pharmacy paid ingredient cost to the pharmacy if the estimated pharmacy paid ingredient cost is less than the maximum pharmacy paid amount and greater than the minimum pharmacy paid amount.

6. A method in accordance with claim 4, wherein determining a maximum pharmacy paid amount comprises calculating the maximum pharmacy paid amount based at least partially on a customary price and a published maximum allowable cost (MAC) price.

7. A method in accordance with claim 4, wherein determining a minimum pharmacy paid amount comprises calculating the minimum pharmacy paid amount based at least partially on an effective discount from a previous year and the maximum pharmacy paid amount.

8. A method in accordance with claim 1, wherein determining an actual pharmacy discount comprises calculating a total of pharmacy paid ingredient costs paid to the pharmacy for generic drugs sold by the pharmacy over the predefined period of time and a total average wholesale price (AWP) of the generic drugs.

9. A method in accordance with claim 8, further comprising receiving transaction data associated with a plurality of prescription drug transactions from the pharmacy, the plurality of prescription drug transactions including the first prescription drug transaction and a second prescription drug transaction through an Nth prescription drug transaction, wherein calculating a total of pharmacy paid ingredient costs comprises calculating, for a transaction N+1, a total of pharmacy paid ingredient costs paid to the pharmacy for the first prescription drug transaction through the Nth prescription drug transaction.

10. A method in accordance with claim 9, wherein calculating a total AWP of the generic drugs comprises calculating, for transaction N+1, the total of the AWP associated with the first prescription drug transaction through the Nth prescription drug transaction.

11. A method in accordance with claim 1, wherein receiving transaction data from the pharmacy comprises receiving transaction data from a plurality of affiliated pharmacies managed by the PBM as a single entity.

12. A method in accordance with claim 1, further comprising storing predicted transaction data associated with predicted transactions and determining the pharmacy discount goal based at least partially on a contract discount goal and the predicted transaction data.

13. A method in accordance with claim 12, wherein determining the pharmacy discount goal comprises:
calculating a change in a price per claim PBM is paying the pharmacy that would cause the actual pharmacy discount to reach the contract discount goal; and
calculating an updated pharmacy discount goal based on the calculated change in price per claim.

14. A system for managing payments between a prescription drug benefits manager (PBM), a pharmacy, and a client of the PBM, the payments made in accordance with a prescription drug benefits plan offered by the client to an individual and managed by the PBM, said system comprising:
at least one input device associated with the pharmacy;
a server system configured to be coupled to said at least one input device, said server system configured to:
receive transaction data associated with a first prescription drug transaction from the pharmacy, the transaction data including data identifying the prescription drug benefits plan and data identifying a first medication and a dosage of the first medication;
determine at least one of a pharmacy discount goal and a client discount goal; and
determine at least one of an actual pharmacy discount provided by the PBM to the pharmacy over a predefined period of time prior to receipt of the transaction data associated with the first prescription drug transaction, and an actual client discount provided by the PBM to the client over the predefined period of time.

15. A system in accordance with claim 14, wherein said server system is further configured to determine at least one of a pharmacy paid ingredient cost for the first prescription drug transaction and a client billed ingredient cost for the first prescription drug transaction, wherein the pharmacy paid ingredient cost is an amount paid by the PBM for reimbursing the pharmacy for performing the first prescription drug transaction, the pharmacy paid ingredient cost based at least partially on the pharmacy discount goal and the actual pharmacy discount, and wherein the client billed ingredient cost is an amount billed by the PBM to reimburse the PBM for performing the first prescription drug transaction, the client billed ingredient cost based at least partially on the client discount goal and the actual client discount.

16. A system in accordance with claim 15, wherein said server system is further configured to determine in real-time an estimated pharmacy paid ingredient cost that if applied to the first prescription drug transaction will adjust the actual pharmacy discount to equal the pharmacy discount goal.

17. A system in accordance with claim 14, wherein said server system is further configured to determine a total of pharmacy paid ingredient costs paid to the pharmacy for generic drugs sold by the pharmacy over the predefined period of time and a total average wholesale price (AWP) of the generic drugs.

18. A computer program embodied on a computer readable medium for managing payments between a prescription drug benefits manager (PBM), a pharmacy, and a client of the PBM, the payments made in accordance with a prescription drug benefits plan offered by the client to an individual and managed by the PBM, said program comprising at least one code segment that instructs a server system to:
receive transaction data associated with a first prescription drug transaction from the pharmacy, the transaction data including data identifying the prescription drug benefits plan and data identifying a first medication and a dosage of the first medication;
determine at least one of a pharmacy discount goal and a client discount goal;
determine at least one of an actual pharmacy discount provided by the PBM to the pharmacy over a predefined period of time, and an actual client discount provided by the PBM to the client over the predefined period of time; and
determine at least one of a pharmacy paid ingredient cost for the first prescription drug transaction and a client billed ingredient cost for the first prescription drug transaction, wherein the pharmacy paid ingredient cost is an amount paid by the PBM for reimbursing the pharmacy for performing the first prescription drug transaction, the pharmacy paid ingredient cost based at least partially on the pharmacy discount goal and the actual pharmacy discount, and wherein the client billed ingredient cost is an amount billed by the PBM to reimburse the PBM for performing the first prescription drug transaction, the client billed ingredient cost based at least partially on the client discount goal and the actual client discount.

19. A program in accordance with claim 18, further comprising at least one code segment that instructs a server system to determine a total of pharmacy paid ingredient costs paid to the pharmacy for generic drugs sold by the pharmacy over the predefined period of time and a total average wholesale price (AWP) of the generic drugs.

20. A program in accordance with claim 18, further comprising at least one code segment that instructs a server system to determine in real-time an estimated pharmacy paid ingredient cost that if applied to the first prescription drug transaction will adjust the actual pharmacy discount to equal the pharmacy discount goal.
